(19) United States
(12) Patent Application Publication
(10) Pub. No.: US 2017/0275190 A1
(43) Pub. Date: Sep. 28, 2017

(54) SYSTEM USING HEAT ENERGY TO PRODUCE POWER AND PURE WATER

(71) Applicant: Solar Turbines Incorporated, San Diego, CA (US)

(72) Inventor: Ifegwu Lekwauwa Kalu EZIYI, Tallahassee, FL (US)

(73) Assignee: Solar Turbines Incorporated, San Diego, CA (US)

(21) Appl. No.: 15/077,973

(22) Filed: Mar. 23, 2016

(51) Int. Cl. C02F 1/44; B01D 61/36; F01K 25/10

(52) U.S. Cl. CPC C02F 1/447; F01K 25/10; B01D 61/364; B01D 61/366; B01D 2313/18; B01D 2313/36; B01D 2313/22; C02F 2103/08

(57) ABSTRACT

A system may be configured to use heat energy to produce power and potable water. The system may include an organic rankine cycle (ORC) subsystem configured to receive heat energy from one or more sources and convert that heat energy into usable power. The system may also include an air gap membrane distillation (AGMD) subsystem configured to receive heat energy from the ORC subsystem and use the heat energy to convert impure water into potable water.

### TECHNICAL FIELD

The present disclosure relates generally to recovery of heat energy from various sources, and, more particularly, use of the recovered heat energy in an integrated system to produce power and pure water.

### BACKGROUND

Throughout the world, the demands for clean, affordable power and potable water present some of the most important challenges facing humanity. Existing technologies are often directed to independently solving either clean energy production problems or the production of safe, potable water. Accordingly, there is a need for solutions that may be able to synergistically solve both clean energy creation and potable water creation problems using common sources of wasted energy, such as waste residual heat energy. Many energy systems, such as, for example, power generation plants, which depend upon an inflow of a heated or super-heated working fluid (e.g., steam or a chemical refrigerant) to turn mechanical energy into electrical energy, produce exhaust gases that are usually extremely hot. These gases are often exhausted into the open atmosphere, thereby wasting any residual heat energy contained therein. Since the operation of such systems depends upon the inflow of a heated or super-heated fluid, the overall efficiency of these systems may be improved by a mechanism, such as, for example, a heat exchanger, configured to recapture at least a portion of the residual waste heat energy for use in preheating the incoming working fluid. Similarly, reciprocating internal combustion engines, turbine engines, sources of solar thermal power, sources of power derived from the combustion of biomass, geothermal sources of heat energy, and other power generating devices may produce residual waste heat energy that may be beneficially recaptured and used in the production of both clean power and potable water.

The use of a waste heat recovery cycle for producing power and fresh water has been addressed in the art by utilizing an aqueous brine, such as sea water to produce steam and liquid droplets, which are then used to drive a turbine. Steam from the turbine is condensed in a heat exchange with the cool aqueous brine to produce fresh water. For instance, the use of such a heat recovery cycle is described in U.S. Pat. No. 4,227,373 issued to Amend et al. on Oct. 14, 1980. Although the '373 patent allegedly produces both power and fresh water, the use of brine as the working fluid, which is heated to produce vapor and liquid droplets used to drive a biphase separator turbine may present significant problems with cavitation and corrosion in the turbine used to produce power. Additionally, the system described in the '373 patent does not provide any means for selectively controlling the relative amounts of power and fresh water that are produced.

The present disclosure is directed to overcoming one or more of the shortcomings set forth above.

### SUMMARY

In one aspect, the present disclosure is directed to a system configured to use heat energy to produce power and potable water. The system may include an organic rankine cycle (ORC) subsystem configured to receive heat energy from one or more sources and convert the heat energy into usable power, and an air gap membrane distillation (AGMD) subsystem configured to receive heat energy from the ORC subsystem and use the heat energy to convert impure water into potable water.

In another aspect, the present disclosure is directed to a method of using waste heat energy to produce power and potable water. The method may include receiving heat energy from one or more sources of waste heat energy, and selectively supplying some of the heat energy to an organic rankine cycle (ORC) subsystem configured to receive the heat energy and convert the heat energy into usable power. The method may further include receiving some of the heat energy from the ORC subsystem at an air gap membrane distillation (AGMD) subsystem configured to use the heat energy to convert impure water into potable water.

In yet another aspect, the present disclosure is directed to a system configured to use heat energy to produce power and potable water. The system may include an organic rankine cycle (ORC) subsystem configured to receive heat energy from one or more sources and convert the heat energy into usable power, and an air gap membrane distillation (AGMD) subsystem configured to receive heat energy from the ORC subsystem and use the heat energy to convert impure water into potable water. The system may also include a first program-controlled valve configured to selectively control an amount of heat recovery performed by a recuperator of the ORC subsystem based on an amount of heat energy needed at the AGMD subsystem to produce a desired amount of the potable water. The system may still further include a second program-controlled valve configured to determine which of the one or more sources of heat energy will yield a working temperature that will result in a desired amount of power generation and potable water production, and supply heat energy from the determined one or more sources of heat energy to at least one of the ORC subsystem or directly to the AGMD subsystem, to produce the desired amount of power with the ORC subsystem, while leaving a sufficient amount of heat energy for exchange with the AGMD subsystem to produce the desired amount of potable water at the AGMD subsystem.

### BRIEF DESCRIPTION OF THE DRAWINGS

FIGS. 1-4 are schematic illustrations of exemplary integrated ORC and AGMD systems in accordance with the present disclosure.

### DETAILED DESCRIPTION

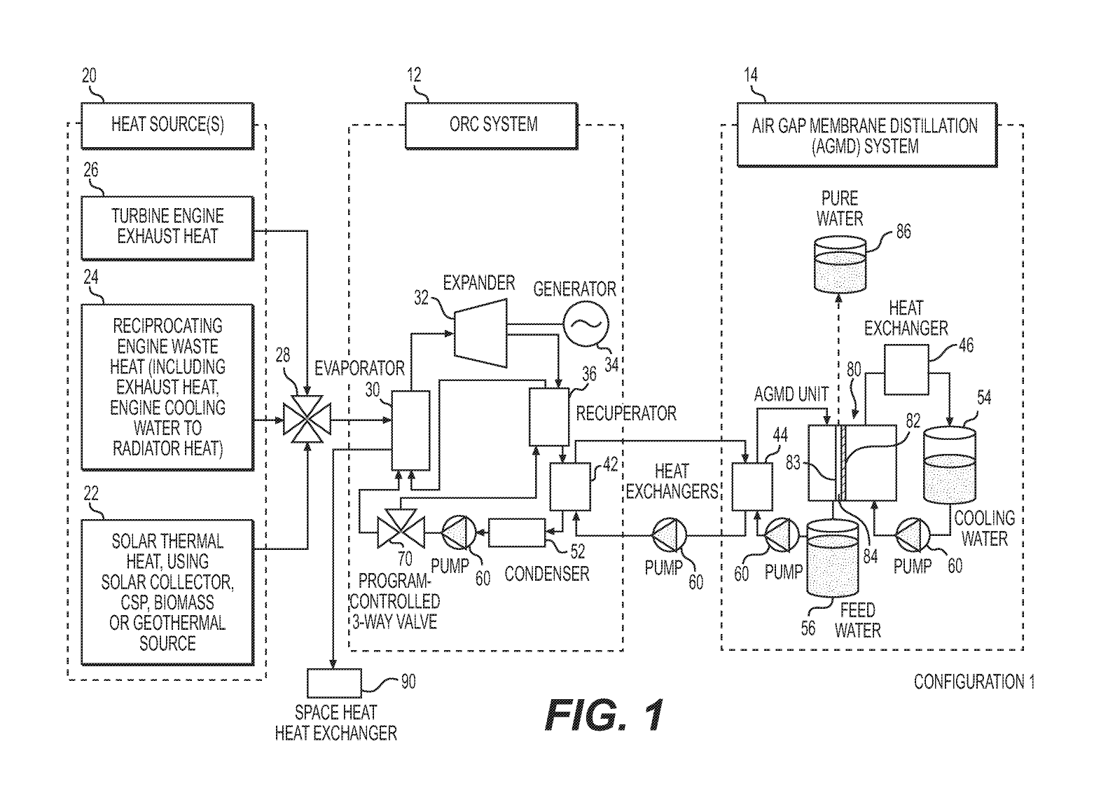

FIG. 1 illustrates an exemplary embodiment of a system in accordance with the present disclosure. The system may include an organic rankine cycle (ORC) subsystem 12 interconnected with an air gap membrane distillation (AGMD) subsystem 14. A rankine cycle is an idealized thermodynamic cycle of a heat engine that converts heat into mechanical work. The heat is supplied externally to a closed loop, which usually uses water as the working fluid. The ORC uses an organic working fluid, such as n-pentane or toluene in place of water and steam. The organic working fluid may have a boiling point that is considerably lower than the boiling point of water, thus allowing the use of lower temperature heat sources. As shown in FIGS. 1-4, examples of heat sources 20 that may be used with the ORC include turbine engine exhaust heat 26, reciprocating engine waste heat (including exhaust heat, and engine cooling water to radiator heat) 24, solar thermal heat (such as may be obtained using a solar collector or concentrated solar power) 22, heat derived from biomass, and heat derived from geothermal sources.

The ORC performed by the ORC subsystem 12 may include four processes that are performed by the various components illustrated in FIGS. 1-4. Heat energy derived from the heat sources 20 may be selectively supplied to the ORC subsystem 12 through a program-controlled valve 28. The program-controlled valve 28 may be configured to determine which of the one or more heat sources will yield the optimal working temperatures for achieving a desired amount of power output from the ORC subsystem, and for producing a desired amount of potable water with the AGMD subsystem. In order to perform these functions, the program-controlled valve 28 may include or be associated with one or more processors configured to include program logic that may, upon execution, cause at least one of a physics-based calculation or a determination from values stored in a memory of the amount of heat energy required for input into the ORC subsystem to produce a desired amount of power output. The one or more processors may also be configured to include program logic that may, upon execution, cause at least one of a physics-based calculation or a determination from values stored in a memory of the amount of heat energy required for input into the ORC subsystem to result in an amount of excess heat energy output from the ORC subsystem and supplied to the AGMD subsystem to create a required temperature difference across an AGMD unit for production of a desired amount of potable water.

The ORC subsystem may be configured to perform a first process of pumping the working fluid from a low pressure to a higher pressure. During this first process, liquid condensate produced by a condenser 52 may be pumped by a pump 60 downstream of the condenser 52 through another program-controlled valve 70 to an evaporator 30. The second process of the ORC may be to receive the higher pressure liquid at the evaporator 30 and heat the high pressure liquid using heat energy from the one or more heat sources 20 to convert the liquid working fluid from the condenser 52 into a dry saturated vapor, free from liquid particles. In a third process, the dry saturated vapor may be expanded through an expander 32. In one exemplary embodiment, the expander 32 may include a turbine that converts the energy from pressure differences created across rotating turbine blades of the turbine as the dry saturated vapor expands through the turbine into rotating kinetic energy that may be used to drive an electric generator 34 and generate electrical power output. Vapor leaving the expander 32 may be diverted through a recuperator 36 and a heat exchanger 42 where heat energy may be extracted for exchange with the AGMD subsystem 14. A fourth process of the ORC may include condensing vapor from the expander 32 after it has passed through the recuperator 36 and heat exchanger 42 to the condenser 52 at a constant pressure to become a saturated liquid.

The saturated liquid downstream of the condenser 52 may be pumped by the pump 60 to a higher pressure before being introduced to the evaporator 30, and the cycle may be repeated. The program-controlled valve 70 downstream of the condenser 52 and pump 60 may include or be associated with program logic in one or more processors configured to selectively supply some of the cooled saturated liquid downstream of the condenser 52 back through the recuperator 36. The recuperator 36 may thereby recover some of the heat energy from the vapor leaving the expander 32 and use that heat energy to preheat the saturated liquid supplied from the condenser 52 to the evaporator 30. The process of selectively diverting some of the cooler saturated working fluid from downstream of the condenser 52 back through the recuperator 36 will reduce the temperature of the working fluid supplied to the heat exchanger 42, and exchanged with the AGMD subsystem. Therefore, a determination of whether to employ the program-controlled valve 70 to divert some of the cooled saturated liquid through the recuperator may be based upon a number of factors including the temperature of the vapor leaving the expander 32, and the amount of heat energy needed at the AGMD subsystem to produce a desired amount of potable water.

The heat exchanger 42 in the ORC subsystem may be in fluid communication with another heat exchanger 44 in the AGMD subsystem 14. The first working fluid in the ORC subsystem may leave the expander 32 in a gaseous form and pass through the recuperator 36 and the heat exchanger 42 before being introduced into the condenser 52. Heat energy from the gaseous form of the first working fluid passing through the heat exchanger 42 may be transferred to a second working fluid that is pumped in a loop between the heat exchanger 42 in the ORC subsystem and a heat exchanger 44 in the AGMD subsystem. In this manner, heat energy recovered from the gaseous working fluid after it has supplied mechanical energy at the expander 32 and the generator 34 of the ORC subsystem may be used in the AGMD subsystem for the purification of water.

As shown in FIG. 1, the heat exchanger 44 in the AGMD subsystem may be included in a closed loop with the heated side of an AGMD unit 80 and a source of impure feed water 56. The feed water 56 may be pumped from the source by a pump 60 in the closed loop through the heat exchanger 44, where it may be heated by the heat energy transferred from the ORC subsystem. The heated feed water leaving the heat exchanger 44 may then be pumped through the heated side of the AGMD unit 80, where the heated feed water is exposed to one side of an internal, porous, hydrophobic membrane 83. The side of the membrane 83 opposite from the side exposed to the heated side of the AGMD unit 80 may be separated by an air gap 84 from a cooled condensing plate 82. The cooled condensing plate 82 may be kept at a temperature that is less than the temperature of the heated side of the AGMD unit 80 as a result of being positioned against the cooled side of the AGMD unit 80. In the exemplary implementation of FIG. 1, the cooled side of the AGMD unit 80 may be included in a second closed loop with a source of cooling water 54 and a heat exchanger 46. The heat exchanger 46 may be any of a variety of types of heat exchangers, including an air-to-water, or liquid-to-water heat exchanger. In yet another variation of the implementation shown in FIG. 1, the heat exchanger 46 included in the second closed loop with the cooled side of the AGMD unit 80 may receive cooled liquid from downstream of the condenser 52. The program-controlled valve 70 may selectively supply all or a portion of the cooled liquid pumped downstream of the condenser 52 before sending the cooled liquid to the recuperator 36, and/or back to the evaporator 30.

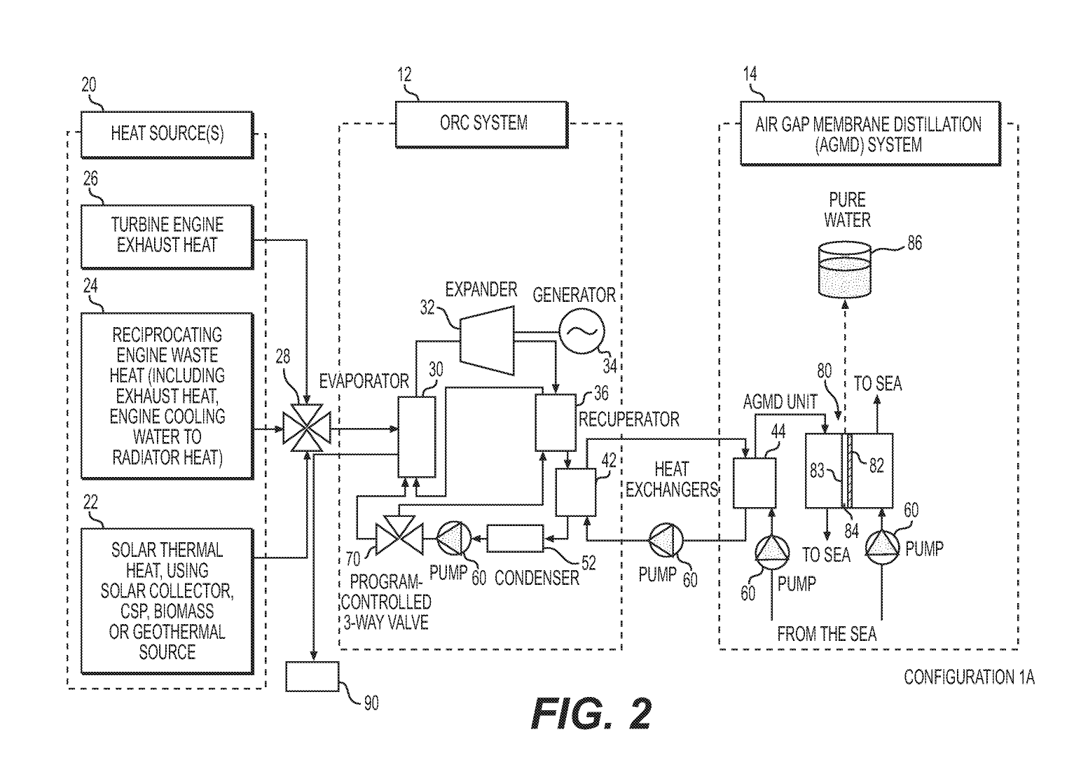

An alternative implementation illustrated in FIG. 2 may provide both the heated side and the cooled side of the AGMD unit 80 in separate open loops that receive feed water or cooling water from the sea and return the feed water or cooling water to the sea after passing through the AGMD unit 80. A pump 60 may pump sea water from the ocean, and supply the sea water as the impure feed water to the heated side of the AGMD unit 80. The feed water may be first pumped through the heat exchanger 44 to receive heat energy transferred from the ORC subsystem 12 and then through the heated side of the AGMD unit 80. At the same time, another pump 60 may pump sea water from the ocean, or any other cooling liquid from another source, through the cooled side of the AGMD unit 80 in order to maintain a desired temperature difference across the internal membrane 83 of the AGMD unit 80.

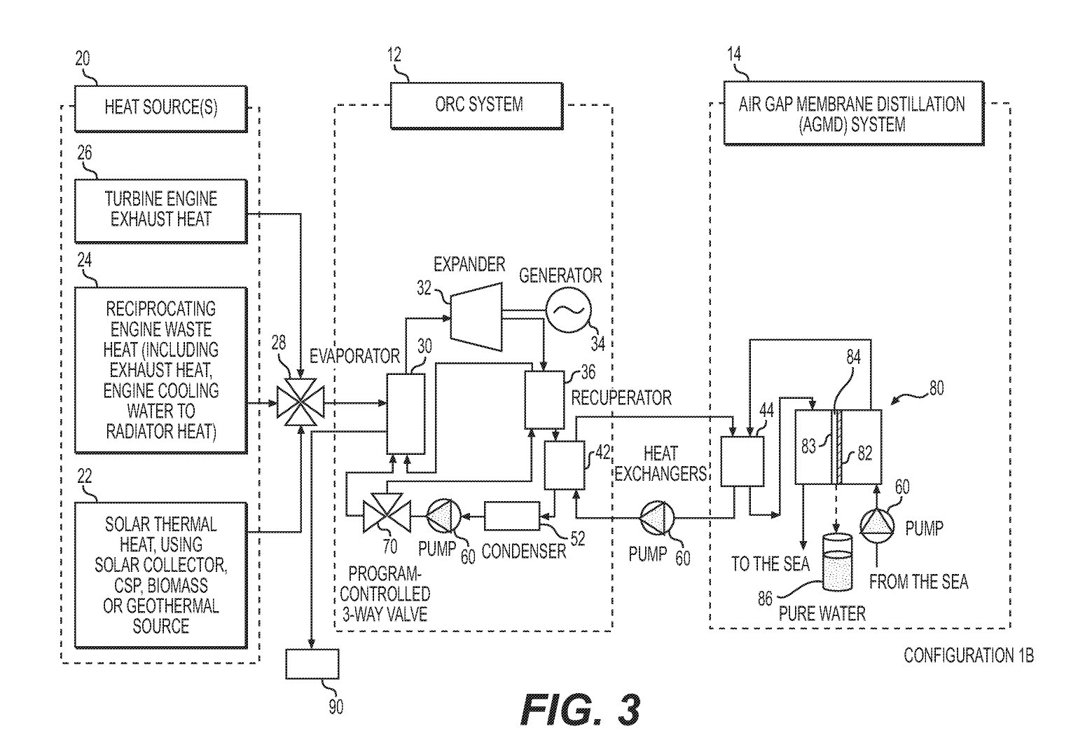

In another alternative implementation shown in FIG. 3, the sea water, or other cooling liquid pumped through the cooled side of the AGMD unit 80 may then be directed through the heat exchanger 44 before being pumped through the heated side of the AGMD unit 80 and returned to its source. As shown in all of the implementations illustrated in FIGS. 1-4, the temperature difference across the internal membrane 83 causes the transport of water vapor from the impure, feed water supplied to the heated side of the AGMD unit 80 through the membrane and across the air gap 84 to condense as pure, potable water on the condensing plate 82. The amount of potable water 86 that may be produced by the AGMD unit 80 may be a function of various parameters including the amount of surface area of the membrane exposed to the heated feed water, the flow rate of feed water through the AGMD unit 80, and the temperature difference across the membrane 83.

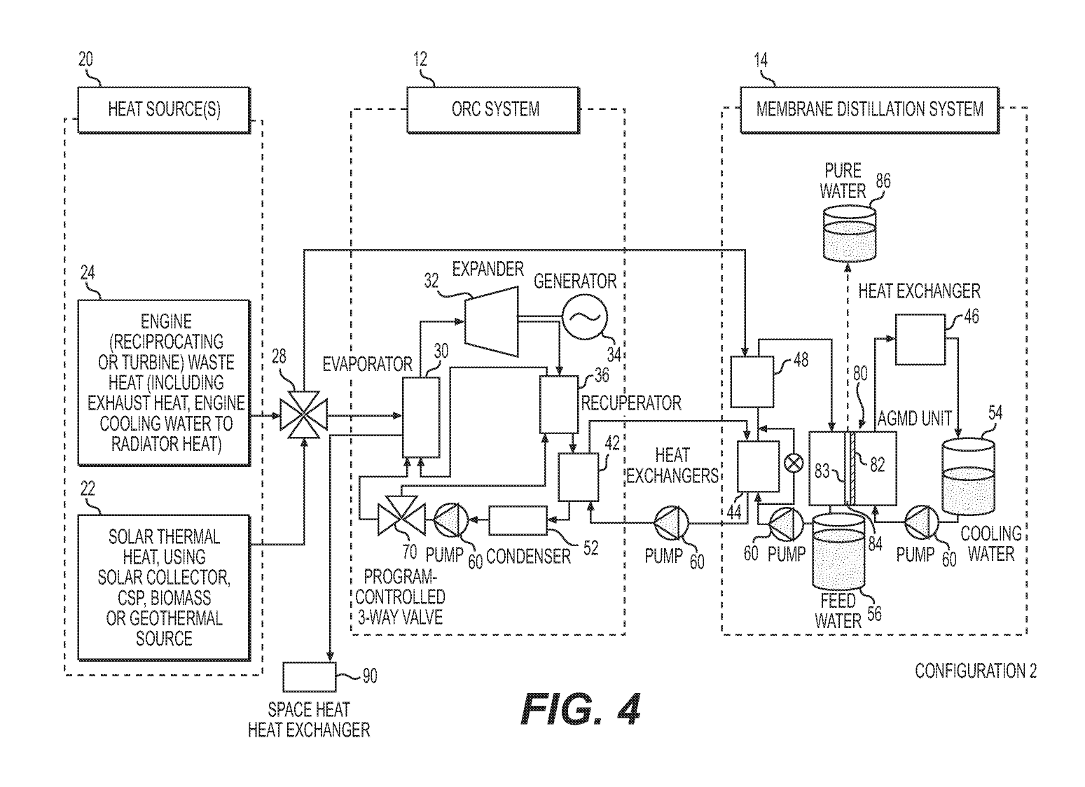

As shown in the alternative implementation of FIG. 4, the program-controlled valve 28, may supply heat energy from one or more heat sources 20 either through the ORC subsystem 12, or directly to the AGMD subsystem 14 depending on a number of different factors. In some situations a demand for pure water may outweigh a demand for power such that it is desirable to send all of the heat energy from the heat sources 20 directly through the heat exchanger 48 in the AGMD subsystem in order to heat the feed water 56 being supplied to the heated side of the AGMD unit 80. There also may be times when the amount of available waste heat energy is sufficient to produce potable water at the AGMD subsystem 14, but insufficient to operate the generator 34 of the ORC subsystem. At other times, various ratios of the amount of heat energy supplied directly to the AGMD subsystem 14 relative to the amount of heat energy supplied to the ORC subsystem 12 may provide the most efficient and effective control of power and potable water production. In the exemplary implementation of FIG. 4, the cooled side of the AGMD unit 80 may be included in a second closed loop with a source of cooling water 54 and a heat exchanger 46. The heat exchanger 46 may be any of a variety of types of heat exchangers, including an air-to-water, or liquid-to-water heat exchanger. In yet another variation of the implementation shown in FIG. 4, the heat exchanger 46 included in the second closed loop with the cooled side of the AGMD unit 80 may receive cooled liquid from downstream of the condenser 52. The program-controlled valve 70 may selectively supply all or a portion of the cooled liquid pumped downstream of the condenser 52 before sending the cooled liquid to the recuperator 36, and/or back to the evaporator 30.

### INDUSTRIAL APPLICABILITY

The system in accordance with various aspects of this disclosure may provide the synergistic benefits of using waste heat energy to produce both power and potable water, as well as providing a heat source for space heating 90 if desired. Heat energy may be received from one or more sources of waste heat energy, and selectively supplied to an organic rankine cycle (ORC) subsystem configured to receive the heat energy and convert the heat energy into usable power. Additionally, some of the heat energy from the ORC subsystem may be transferred to an air gap membrane distillation (AGMD) subsystem configured to use the heat energy to convert impure water into potable water. As discussed above, the ORC subsystem 12 may include a program-controlled valve 70 configured to selectively divert some of the cooler liquid working fluid downstream of the condenser 52 back through the recuperator 36. The program logic associated with the program-controlled valve 70 may cause the diversion of the cooler liquid through the recuperator 36, thereby reducing the temperature of the gaseous working fluid passing through the recuperator 36 from the expander 32. The determination of whether to permit this heat exchange in the recuperator 36, resulting preheat of the working fluid supplied to the evaporator 30, and reduction of the temperature of gaseous working fluid exiting the recuperator 36, may be based at least in part on the heat energy required from the recuperator for exchange with the AGMD subsystem. The program logic may receive input from the AGMD subsystem, including how much heat energy is required to maintain a temperature differential across the AGMD unit 80 of the AGMD subsystem sufficient to produce a desired amount of potable water. In one exemplary implementation, the program-controlled valve 70 may prevent the diversion of any of the cooler liquid working fluid downstream of the condenser 52 back to the recuperator 36 during cold start-up, or any other periods of time when the heat energy supplied to the evaporator 30 is not sufficient to meet the requirements of the ORC subsystem for producing power. Once the working temperature of the gaseous working fluid leaving the evaporator 30 and passing through the expander 32 of the ORC subsystem is sufficient for the production of a desired amount of power, the program-controlled valve 70 may then divert a portion of the cooler liquid working fluid back through the recuperator 36.

The AGMD unit 80 of the AGMD subsystem 14 may include a heated side and a cooled side, with an internal, hydrophobic, porous membrane 83 contacting the heated side of the AGMD unit on one of two opposing faces of the membrane. A cooled condensing plate 82 made from a food-grade, highly thermally conductive material, such as stainless steel, may contact the cooled side of the AGMD unit, with an air gap 84 defined in between the membrane 83 and the cooled condensing plate 82.

In the exemplary implementation shown in FIG. 1, a method performed by the system in accordance with this disclosure may include heating impure feed water 56 in the AGMD subsystem 14 by exchanging heat energy received from the ORC subsystem 12 at a heat exchanger 44 of the AGMD subsystem 14 with the impure feed water. The heated feed water may then be supplied to the heated side of the membrane 83 in the AGMD unit 80. The heat energy received by the AGMD unit generates a temperature difference and thereby a vapor pressure gradient across the internal membrane 83, and the vapor pressure gradient results in the transport of water vapor derived from the impure feed water across the membrane and across the air gap 84 to condense as potable water on the cooled condensing plate 82. The membrane distillation process is a thermally driven process, in which only vapor molecules are transported through the porous membrane 83. Evaporation of impure feed water occurs on the heated side of the membrane 83, and condensation of the vapor molecules occurs on the cooled condensing plate 82 to form potable water.

The ORC subsystem 12 may receive waste heat energy from a plurality of different sources. The program-controlled valve 28 may be configured to determine which of the plurality of heat sources 20 are best suited at any given time for supplying a required amount of heat energy to an evaporator of the ORC subsystem. Program logic associated with the program-controlled valve 28 may determine which of the one or more sources of heat energy will yield a working temperature for at least one of the ORC subsystem and the AGMD subsystem that will result in a desired amount of power generation and potable water production. The program logic may cause the program-controlled valve 28 to supply heat energy from the determined one or more sources of heat energy to the ORC subsystem to produce power with the ORC, and produce potable water with the AGMD subsystem in predetermined relative amounts.

The program logic associated with the program-controlled valve 28 may receive data inputs from various sensors associated with both the components and outputs of the ORC subsystem and the components and outputs of the AGMD subsystem 14. In various exemplary implementations, data received at the program-controlled valve 28 may, for example, provide information that one or more sources of heat energy at relatively lower temperatures may be best suited for maintaining power production by the ORC subsystem at present levels, while resulting in an efficient exchange of heat energy with the AGMD subsystem sufficient to optimize the temperature difference across the membrane 83 of the AGMD unit 80 for production of a desired amount of potable water. In other implementations, data received at the program-controlled valve 28 may result in a change to at least one higher temperature source of heat energy when more power output from the ORC subsystem is required while the demands for potable water are already being met.

Heat energy received at the evaporator 30 of the ORC subsystem 12 may result in the phase change of the first working fluid circulated in the ORC subsystem from a liquid to a gaseous form. The gaseous form of the working fluid may then pass through the expander 32. The expander 32 may convert at least a portion of the heat energy received from the gaseous form of the first working fluid to mechanical energy as a result of a pressure difference created across internal, rotating components of the expander as the first working fluid passes through the expander. The mechanical energy from the expander 32 may be used to drive the generator 34 for the production of electrical power, which can be output from the ORC subsystem 12. The recuperator 36 downstream of the expander 32 may receive at least a portion of the gaseous form of the first working fluid expelled from the expander 32. The gaseous form of the first working fluid leaving the recuperator may then exchange heat energy at the heat exchanger 42 with a second working fluid that supplies the heat energy to the heat exchanger 44 of the AGMD subsystem. The recuperator 36 allows for the recapture of some of the heat energy from the gaseous form of the working fluid exiting the expander 32, and transfer of that heat energy to pre-heat the cooled liquid condensate leaving the condenser 52 before it is evaporated again in the evaporator 30. This extraction of heat energy from the gaseous working fluid passing through the recuperator 36 may be discontinued by controlling the program-controlled valve 70 to stop the diversion of any of the cooler liquid working fluid back through the recuperator. As discussed above, a determination of whether to divert any of the cooler liquid working fluid downstream of the condenser 52 back through the recuperator 36 may be based at least in part upon an amount of heat energy needed at the AGMD subsystem to produce a desired amount of the potable water.

In the exemplary implementation illustrated in FIG. 1, the impure feed water 56 may be pumped by the pump 60 in a closed loop that includes the heated side of the AGMD unit 80 and a heat exchanger 44 of the AGMD subsystem 14. The heat exchanger 44 of the AGMD subsystem 14 may be in fluid communication with the heat exchanger 42 of the ORC subsystem 12 downstream of the recuperator 36, and may be configured for exchanging heat energy with the ORC subsystem. Cooling water 54 may be pumped by another pump 60 in another closed loop that includes the cooled side of the AGMD unit 80 and a heat exchanger 46. As discussed above, the heat exchanger 46 may be any of a variety of types of heat exchangers, including an air-to-water, or liquid-to-water heat exchanger. The heat exchanger 46 may also receive cooled liquid from downstream of the condenser 52. The program-controlled valve 70 may selectively supply all or a portion of the cooled liquid pumped downstream of the condenser 52 before sending the cooled liquid to the recuperator 36, and/or back to the evaporator 30. The condensing plate 82 may be positioned against the cooled side of the AGMD unit 80 on the opposite side of the air gap 84 from the membrane 83.

In an alternative implementation shown in FIG. 2, the pump 60 may pump sea water in an open loop that includes the heated side of the AGMD unit 80 and the heat exchanger 44 of the AGMD subsystem 14, with the heat exchanger 44 of the AGMD subsystem 14 again being in fluid communication with the heat exchanger 42 of the ORC subsystem 12 downstream of the recuperator 36. The sea water supplied to the heated side of the AGMD unit 80 may be returned to the sea after being heated in the heat exchanger 44 with heat energy transferred from the ORC subsystem and passed by the heated side of the internal membrane 83 while passing through the AGMD unit 80. Sea water may also be pumped in an open loop through the cooled side of the AGMD unit 80 to cool the condensing plate 82 and provide a desired temperature differential across the internal membrane 83.

In another alternative implementation shown in FIG. 3, the cooling sea water may be pumped through the cooled side of the AGMD unit 80. The sea water may then be supplied to the heat exchanger 44 of the AGMD subsystem where it may be heated with the heat energy transferred from the ORC subsystem 12 before being passed by the heated side of the internal membrane 83 in the AGMD unit 80 and returned to the sea.

FIG. 4 illustrates yet another alternative implementation wherein the program-controlled valve 28 may selectively supply waste heat energy from one or more of the heat sources 20 directly to the AGMD subsystem 14, without first being used in the ORC subsystem 12 for the production of power. The heat energy from one or more heat sources 20 may be supplied by the program-controlled valve 28 directly to a heat exchanger 48 in the AGMD subsystem 14, where the heat energy may be transferred to impure feed water 56 being supplied to the heated side of the AGMD unit 80. Before passing through the heat exchanger 48, the impure feed water 56 may be pumped through the heat exchanger 44 to additionally receive heat energy transferred by a second working fluid from the heat exchanger 42 of the ORC subsystem. Alternatively, the feed water may be diverted around the heat exchanger 44 and sent directly through the heat exchanger 48 to receive heat energy directly from the heat sources 20. As further shown in FIG. 4, cooling water 54 may be pumped in a closed loop that includes the cooled side of the AGMD unit 80 and the heat exchanger 46. As discussed above, the heat exchanger 46 may be any of a variety of types of heat exchangers, including an air-to-water, or liquid-to-water heat exchanger. The heat exchanger 46 may also receive cooled liquid from downstream of the condenser 52. The program-controlled valve 70 may selectively supply all or a portion of the cooled liquid pumped downstream of the condenser 52 before sending the cooled liquid to the recuperator 36, and/or back to the evaporator 30.

It will be apparent to those skilled in the art that various modifications and variations can be made to the combined ORC and AGMD system of the present disclosure without departing from the scope of the disclosure. For example, the AGMD unit may comprise a parallel combination of multiple stages, wherein each stage may include a feed water channel, a synthetic membrane sheet, an air gap for product water, a condensing plate, and a cooling water channel. The entire system, including one or more heat sources, the ORC subsystem, and the AGMD subsystem, may also be coupled to renewable energy components such as photovoltaic panels and/or wind turbines for additional production of electricity. In addition, other embodiments will be apparent to those skilled in the art from the consideration of the specification and practice of the system disclosed herein. It is intended that the specification and examples be considered as exemplary only, with a true scope of the disclosure being indicated by the following claims and their equivalents.

What is claimed is:

1. A system configured to use heat energy to produce power and potable water, the system comprising:
an organic rankine cycle (ORC) subsystem configured to receive heat energy from one or more sources and convert the heat energy into usable power; and
an air gap membrane distillation (AGMD) subsystem configured to receive heat energy from the ORC subsystem and use the heat energy to convert impure water into potable water.

2. The system of claim 1, wherein the AGMD subsystem includes an AGMD unit, and wherein the AGMD unit includes a heated side configured to receive impure feed water, an internal hydrophobic membrane contacting the heated side on one face of the membrane, a cooled side configured to receive cooling fluid, a cooled condensing plate contacting the cooled side, and an air gap defined in between the hydrophobic membrane and the cooled condensing plate.

3. The system of claim 2, wherein the heat energy received by the AGMD subsystem generates a temperature difference and thereby a vapor pressure gradient across the internal hydrophobic membrane, the vapor pressure gradient resulting in the transport of water vapor derived from the impure feed water across the membrane and across the air gap to condense as potable water on the cooled condensing plate.

4. The system of claim 1, wherein the ORC subsystem includes:
an evaporator configured to receive the heat energy from one or more sources and apply that heat energy to a first working fluid to convert the first working fluid into a gaseous form;
an expander configured to receive the gaseous form of the first working fluid and convert a portion of the heat energy received from the gaseous form of the first working fluid to mechanical energy as a result of a pressure difference created across internal components of the expander as the first working fluid passes through the expander;
a generator driven by the mechanical energy received from the expander to produce electrical power;
a recuperator positioned downstream of the expander and upstream of a condenser, the recuperator being configured to receive the gaseous form of the first working fluid from the expander and selectively exchange heat energy from the gaseous form of the first working fluid with a relatively colder liquid form of the first working fluid selectively diverted from a downstream side of the condenser; and
a program-controlled valve configured to selectively control the supply of a portion of the colder liquid form of the first working fluid downstream of the condenser to the recuperator as a function of the amount of heat energy needed at the AGMD unit to produce a desired amount of the potable water.

5. The system of claim 4, wherein the ORC subsystem further includes a heat exchanger downstream of the recuperator configured to exchange heat energy from the first working fluid exiting the recuperator with a second working fluid pumped between the ORC subsystem and a heat exchanger of the AGMD subsystem.

6. The system of claim 2, wherein the AGMD unit includes the hydrophobic membrane being made from a porous synthetic material, the condensing plate being made from stainless steel, and the condensing plate being spaced from the hydrophobic membrane by an air gap.

7. The system of claim 2, wherein the ORC subsystem includes a program-controlled valve configured to selectively control the amount of heat energy supplied from the ORC subsystem to the AGMD subsystem based on a temperature difference needed in the AGMD unit between the heated side and the cooled side of the AGMD unit to produce a desired amount of the potable water.

8. The system of claim 1, further including a program-controlled valve configured to determine which of the one or more sources of heat energy will yield a working temperature that will result in a desired amount of power generation and potable water production, and supply heat energy from the determined one or more sources of heat energy to the ORC subsystem to produce the desired amount of power with the ORC subsystem, while leaving a sufficient amount of heat energy for exchange between the ORC subsystem and the AGMD subsystem to produce the desired amount of potable water at the AGMD subsystem.

9. The system of claim 2, wherein at least one of the heated side and the cooled side of the AGMD unit is part of one of a closed loop including one or more heat exchangers configured for exchanging heat energy with one or more of the ORC subsystem, a source of impure feed water, a source of cooling liquid, and ambient air, or an open loop configured to at least one of receive a flow of cooling liquid or discharge a flow of cooling liquid.

10. A method of using waste heat energy to produce power and potable water, the method comprising:
receiving heat energy from one or more sources of waste heat energy;
selectively supplying some of the heat energy to an organic rankine cycle (ORC) subsystem configured to receive the heat energy and convert the heat energy into usable power; and
receiving some of the heat energy from the ORC subsystem at an air gap membrane distillation (AGMD) subsystem configured to use the heat energy to convert impure water into potable water.

11. The method of claim 10, wherein an AGMD unit of the AGMD subsystem includes a heated side and a cooled side with an internal membrane contacting the heated side on one face of the membrane, a cooled condensing plate contacting the cooled side, and an air gap defined in between the membrane and the cooled condensing plate, the method including heating impure feed water by exchanging heat energy received from the ORC subsystem with the impure feed water, and supplying the heated feed water to the heated side of the membrane in the AGMD unit.

12. The method of claim 11, wherein the heat energy received by the AGMD unit generates a temperature difference and thereby a vapor pressure gradient across the internal membrane, the vapor pressure gradient resulting in the transport of water vapor derived from the impure feed water across the membrane and across the air gap to condense as potable water on the cooled condensing plate.

13. The method of claim 10, further including:
receiving the heat energy at an evaporator of the ORC subsystem configured to transfer the heat energy to a first working fluid to convert the first working fluid into a gaseous form;
receiving the gaseous form of the first working fluid at an expander configured to convert a portion of the heat energy received from the gaseous form of the first working fluid to mechanical energy as a result of a pressure difference created across internal components of the expander as the first working fluid passes through the expander;
applying the mechanical energy to a generator to produce electrical power;
receiving at least a portion of the gaseous form of the first working fluid from the expander at a recuperator positioned downstream of the expander and upstream of a condenser; and
selectively diverting a determined portion of a relatively colder liquid form of the first working fluid from a downstream side of the condenser to the recuperator using a program-controlled valve, wherein a determination of the diverted portion is based at least in part upon an amount of heat energy needed at the AGMD subsystem to produce a desired amount of the potable water.

14. The method of claim 10, further including determining which of the one or more sources of heat energy will yield a working temperature for at least one of the ORC subsystem and the AGMD subsystem that will result in a desired amount of power generation and potable water production, and supplying heat energy from the determined one or more sources of heat energy to the ORC subsystem to produce power with the ORC, and produce potable water with the AGMD subsystem in predetermined relative amounts.

15. The method of claim 11, further including pumping impure feed water in a closed loop that includes the heated side of the AGMD unit and a heat exchanger of the AGMD subsystem, the heat exchanger of the AGMD subsystem being in fluid communication with a heat exchanger of the ORC subsystem downstream of the recuperator and being configured for exchanging heat energy with the ORC subsystem.

16. The method of claim 11, further including pumping sea water in an open loop that includes the heated side of the AGMD unit and a heat exchanger of the AGMD subsystem, the heat exchanger of the AGMD subsystem being in fluid communication with a heat exchanger of the ORC subsystem downstream of the recuperator and being configured for exchanging heat energy with the ORC subsystem.

17. The method of claim 13, further including pumping cooling water in a closed loop that includes a cooled side of an AGMD unit of the AGMD subsystem and a heat exchanger that exchanges heat from the cooled side of the AGMD unit with one of ambient air or at least a portion of the relatively colder liquid form of the first working fluid diverted from a downstream side of the condenser using the program-controlled valve.

18. The method of claim 11, further including pumping sea water in an open loop that includes the cooled side of the AGMD unit.

19. A system configured to use heat energy to produce power and potable water, the system comprising:
an organic rankine cycle (ORC) subsystem configured to receive heat energy from one or more sources and convert the heat energy into usable power; and
an air gap membrane distillation (AGMD) subsystem configured to receive heat energy from the ORC subsystem and use the heat energy to convert impure water into potable water;
a first program-controlled valve configured to selectively control an amount of heat recovery performed by a recuperator of the ORC subsystem based on an amount of heat energy needed at the AGMD subsystem to produce a desired amount of the potable water; and
a second program-controlled valve configured to determine which of the one or more sources of heat energy will yield a working temperature that will result in a desired amount of power generation and potable water production, and supply heat energy from the determined one or more sources of heat energy to at least one of the ORC subsystem or directly to the AGMD subsystem, to produce the desired amount of power with the ORC subsystem, while leaving a sufficient amount of heat energy for exchange with the AGMD subsystem to produce the desired amount of potable water at the AGMD subsystem.

20. The system of claim 19, wherein the AGMD subsystem includes an AGMD unit including a heated side and a cooled side incorporated into at least one of a closed loop including one or more heat exchangers configured for exchanging heat energy with one or more of the ORC subsystem, a source of impure feed water, a source of cooling liquid, and ambient air, and an open loop configured to at least one of receive a flow of cooling liquid or discharge a flow of cooling liquid.
